(19) United States
(12) Patent Application Publication
(10) Pub. No.: US 2013/0169663 A1
(43) Pub. Date: Jul. 4, 2013

(54) APPARATUS AND METHOD FOR DISPLAYING IMAGES AND APPARATUS AND METHOD FOR PROCESSING IMAGES

(71) Applicant: Samsung Electronics Co., Ltd., Suwon-si (KR)

(72) Inventors: Hwa-seok SEONG, Suwon-si (KR); Sung-soo KIM, Suwon-si (KR)

(73) Assignee: SAMSUNG ELECTRONICS CO., LTD., Suwon-si (KR)

(21) Appl. No.: 13/710,619

(22) Filed: Dec. 11, 2012

(30) Foreign Application Priority Data
Dec. 30, 2011 (KR) 10-2011-0147534
Dec. 30, 2011 (KR) 10-2011-0147539
May 23, 2012 (KR) 10-2012-0055001

(51) Int. Cl. G09G 5/10; G09G 5/00

(52) U.S. Cl. CPC G09G 5/10; G09G 5/00
USPC 345/589

(57) ABSTRACT

An apparatus and method for displaying images and an apparatus and method for processing images are provided. The image display apparatus includes an image processor configured to receive an image frame and convert a gradation value of each of a plurality of pixels constituting the image frame to generate a sub image frame; and a controller configured to control a display panel to sequentially display the image frame and the sub image frame.

### CROSS-REFERENCE TO RELATED APPLICATION

This application claims priority from Korean Patent Application Nos. 10-2011-0147534, filed on Dec. 30, 2011, 10-2011-0147539, filed on Dec. 30, 2011, and 10-2012-0055001, filed on May 23, 2012, in the Korean Intellectual Property Office, the disclosures of which are hereby incorporated herein by reference in their entirety.

### BACKGROUND

1. Field

Apparatuses and methods consistent with exemplary embodiments relate to an apparatus and method for displaying images and an apparatus and method for processing images, and more particularly, to a device and method for displaying images and a device and method for processing images, which are capable of improving image sticking and low gradation reproduction using sub-frame data, and minimizing degradation of luminance of an overall screen region by partially controlling only luminance of a region in which image sticking occurs, thereby improving picture quality in an image display apparatus such as an organic light emitting display (OLED).

2. Description of the Related Art

In recent years, research on flat panel display apparatuses such as OLEDs, plasma display panels (PDPs), liquid crystal displays (LCDs), which have a lower weight and are smaller in size than cathode-ray tubes (CRTs) is actively progressing.

The plasma display apparatus displays an image using plasma generated by gas discharge and the LCD apparatus displays an image by controlling transmittance of light passing through an LC layer through control of an intensity of an electric field applied to the LC layer which is interposed between two substrates and has a dielectric anisotropy. The OLED apparatus displays an image using electroluminance of a specific organic material or polymer, that is, emitting of light by the application of current.

Among the flat panel display apparatuses, the OLED apparatus is a self-emissive device without a separate back light configured to provide light from a rear of a LC panel and thus is thinner than an LCD apparatus which uses a separate back light. Although not shown, the OLED apparatus has a structure in which Red, Green, and Blue OLEDs are arranged between a single power voltage V_{DD} provided from a power supply terminal and a ground voltage V_{SS} of a power ground terminal, and a switching element such as field effect transistor (FET) is connected between each of the OLEDs and power supply terminal.

The driving scheme of OLED apparatus in the related art is classified into a reset time, a scan time, and an emission time.

In the OLED apparatus, when a unit frame for a specific image starts, a voltage is applied to reset the capacitor and compensate for variation in a threshold voltage of a driving transistor in the reset time, data corresponding to a display vertical resolution is scanned in the scan time, and the OLED actually emits light in the emit time.

In driving the OLED described above, when an image having high gradation data is continuously displayed in any position of an OLED panel over a constant period of time, so-called image sticking, in which a constant luminance quality of the high gradation data remains in the position after high gradation conversion, occurs and the lifespan of the panel is shortened.

In the OLED apparatus in the related art, the number of bits in a digital-to-analog (DAC) converter circuit of a source driver integrated circuit (IC) has to be increased and thus higher costs are incurred. Further, a large number of voltage steps are necessary in the limited driving voltage range and thus a low gradation display is limited.

### SUMMARY

One or more exemplary embodiments may overcome the above disadvantages and other disadvantages not described above. However, it is understood that one or more exemplary embodiment are not required to overcome the disadvantages described above, and may not overcome any of the problems described above.

One or more exemplary embodiments provide an apparatus and method for displaying images, which are capable of preventing image sticking which is a factor of degradation in picture quality and enabling a gradation display of 10 bits or more.

One or more exemplary embodiments provide an apparatus and method for processing images, which are capable of improving picture quality due to image sticking by dividing a spatial area in a screen into a plurality of blocks and controlling the maximum gradation data for the blocks.

According to an aspect of an exemplary embodiment, there is provided an apparatus for displaying images. The apparatus may include: an image processor configured to receive an image frame and convert a gradation value of each of a plurality pixels constituting the image frame to generate a sub image frame; and a controller configured to control a display panel to sequentially display the image frame and the sub image frame.

The image processor may convert the gradation value of each pixel of the plurality of pixels of the image frame according to a relation equation V_{sub}=Vₘₐₓ−Vₘₐᵢₙ, wherein V_{sub} is a gradation value of a pixel from among the plurality of pixels of the sub image frame, Vₘₐₓ is a maximum gradation value, and Vₘₐᵢₙ is a gradation value of a pixel from among the plurality of pixels of the image frame, and generate the sub image frame according to the conversion result.

The controller may control the display panel to display the sub image frame during a display time shorter than a display time of the image frame.

The image processor may convert the gradation value of each pixel of the plurality of pixels of the image frame based on a luminance difference between a target luminance value corresponding to the gradation value of each pixel of the plurality of pixels of the image frame and a real luminance value and generate the sub image frame according to the conversion result.

The image processor may control a gamma value to adjust a maximum luminance and a minimum luminance of the sub image frame.

The controller may determine the display time of the sub image frame based on a luminance difference between a target luminance value corresponding to a gradation value of the image frame and a real luminance value and drive the display panel to display the sub image frame for the determined display time.

The controller may control the display time so that a maximum luminance value in the luminance difference is a maximum luminance of the sub image frame and a minimum difference value in the luminance difference is a minimum luminance of the sub image frame.

The display time of the sub image frame may be changed.

According to another aspect of an exemplary embodiment, there is provided an apparatus for displaying images. The apparatus may include: an image processor configured to compare image frames and perform conversion for gradation value of a block from among a plurality of blocks when consecutive image frames including the block having a gradation value within a preset range are present; and a display panel configured to display the image frames having gradation values converted in the image processor.

The apparatus may further include a frame storage configured to store the image frames. The image processor may compare the image frames stored in the frame storage to determine whether or not the consecutive image frames including the block having the gradation value within the preset range are present, and perform the conversion for gradation value on the block from among the plurality of blocks in at least one image frame of the consecutive image frames.

The image processor may perform the conversion for a gradation value on the block from among the plurality of blocks having the gradation value within the preset range in image frames subsequent to the consecutive image frames.

The apparatus may further include a controller configured to determine a driving time corresponding to a gradation value of the block from among the plurality of blocks, and a light-emitting controller configured to control the display panel to be emitted in the block from among the plurality of blocks according to the determined driving time.

The image processor may provide a frame accumulation result in which high gradation values that are greater than a predetermined gradation values are accumulated for each block of the plurality of blocks. The controller may control the light-emitting controller to adjust the driving time of the image frame for each block of the plurality of blocks based on the frame accumulation result.

The image processor may include: an image divider configured to divide an image frame into block units; a frame comparison device configured to compare a pixel value of previous frame data with a pixel value of current frame data in units of blocks and determine whether or not the comparison result is equal to or smaller than a reference value; a storage configured to accumulate pixels in which the comparison result is equal to or smaller than the reference value as a result of the determination result and store the accumulation result; a property analyzer configured to analyze properties of the accumulated pixels stored in the storage; and a pixel value adjuster configured to change high gradation values greater than a predetermined gradation value of the accumulated pixel in units of blocks based on the analysis result of the property analysis unit and output the changed gradation values.

The property analyzer may include a time function weighting device configured to weight a time function according to a frequency of the pixels accumulated in units of blocks, and the pixel value adjuster may use the weighting result as the analysis result.

The property analyzer may include a brightness calculator configured to calculate average brightness of the pixels accumulated in units of blocks, and the pixel value adjuster may use the calculation result of the average brightness of the brightness calculator as the analysis result.

The pixel value adjuster may adjust a change range of the high gradation values greater than the predetermined gradation value based on a difference value between the consecutive image frames and a temporal retention degree of the difference value.

The pixel value adjuster may increase the change range of the high gradation values greater than the predetermined gradation value when the temporal retention degree is greater than a predetermined temporal retention degree.

The image processor may set a driving time of a color emitting element in the display panel to be shortened when the high gradation value is greater than a predetermined temporal retention degree.

According to another aspect of an exemplary embodiment, there is provided an apparatus for processing images. The apparatus may include: an image divider configured to divide image data of a unit frame into block units; a frame comparison devic configured to compare difference between a a pixel value of previous frame data with a pixel value of current frame data in units of blocks and determine whether or not the comparison result is equal to or smaller than a reference value; a storage configured to accumulate pixels in which the comparison result is equal to or smaller than the reference value as a result of the determination result and store the accumulation result; a property analyzer configured to analyze properties of the accumulated pixels stored in the storage; and a pixel value adjuster configured to change the high gradation values greater than a predetermined gradation value of the accumulated pixel in units of blocks based on the analysis result of the property analyzer and output the gradation values.

The property analyzer may include a time function weighting device configured to weight a time function according to a frequency of the pixels accumulated in units of blocks, and the pixel value adjuster may use the weighting result as the analysis result.

The time function weighting device may set a weight value to be higher when the frequency becomes larger.

The property analyzer may include a brightness calculator configured to calculate average brightness of the pixels accumulated in units of blocks, and the pixel value adjuster may use the calculation result of the average brightness of the brightness calculator as the analysis result.

The pixel value adjuster may adjust a change range of the high gradation values greater than the predetermined gradation value based on a difference value between the consecutive image frames and a temporal retention degree of the difference value.

The pixel value adjuster may increase the change range of the high gradation values greater than the predetermined gradation value when the temporal retention degree is greater than a predetermined temporal retention degree.

According to another aspect of an exemplary embodiment, there is provided a method of displaying images. The method may include: generating a sub image frame by receiving an image frame by converting a gradation value of each of a plurality of pixels constituting the image frame; and driving a display panel to sequentially display the image frame and the sub image frame.

The generating a sub image frame may include converting the gradation value of each pixel of the plurality pixels of the image frame according to a relation equation V_{sub}=Vₘₐₓ−Vₘₐᵢₙ, wherein V_{sub} is a gradation value of a pixel from among the plurality of pixels of the sub image frame, Vₘₐₓ is a maximum gradation value, and Vₘₐᵢₙ is a gradation value of a pixel from among the plurality of pixels of the image frame, and generating the sub image frame according to the conversion result.

The driving a display panel may include driving the display panel to display the sub image frame during a display time shorter than a display time of the image frame.

The generating a sub image frame may include converting the gradation value of each pixel of the plurality of pixels of the image frame based on a luminance difference between a target luminance value corresponding to the gradation value of each pixel of the plurality of pixels of the image frame and a real luminance value and generating the sub image frame according to the conversion result.

The generating a sub image frame may include controlling a gamma value to adjust a maximum luminance and a minimum luminance of the sub image frame.

The driving the display panel may include determining a display time of the sub image frame based on a luminance difference between a target luminance value corresponding to a gradation value of the image frame and a real luminance value and controlling the display panel to display the sub image frame for the determined display time.

The driving a display panel may include controlling the display time so that a maximum luminance in the luminance difference is a maximum luminance of the sub image frame and a minimum difference in the luminance difference is a minimum luminance of the sub image frame.

The display time of the sub image frame may be changed.

According to another aspect of an exemplary embodiment, there is provided a method of displaying images. The method may include: comparing image frames and performing conversion for a gradation value of a block from among a plurality of blocks when consecutive image frames including the block having the gradation value within a preset range are present; and displaying the image frames having the converted gradation value.

The method may further include storing the image frames. The performing conversion for a gradation value of the block from among a plurality of blocks may include: comparing the stored image frames to determine whether or not the consecutive image frames including the block having the gradation value within the preset range are present; and performing the conversion for gradation value of the block from among a plurality of blocks in at least one image frame of the consecutive image frames.

The performing conversion for a gradation value of the block from among the plurality of blocks may include performing the conversion for a gradation value on the block having the gradation value within the preset range in image frames subsequent to the consecutive image frames.

The method may further include: determining a driving time corresponding to a gradation value of the block from among the plurality of blocks, and performing a display operation on the block from among the plurality of blocks according to the determined driving time.

The performing conversion for a gradation value of the block from among the plurality of blocks may include providing a frame accumulation result in which high gradation values that are greater than a predetermined gradation values are accumulated for each block of the plurality of blocks to a controller. The controller may adjust a driving time of the image frame for each block of the plurality of blocks based on the frame accumulation result.

The performing conversion for a gradation value in units of blocks may include: diving the image frame into block units; comparing a pixel value of previous frame data with a pixel value of current frame data in units of blocks and determining whether or not the comparison result is equal to or smaller than a reference value; accumulating pixels in which the comparison result is equal to or smaller than the reference value as a result of the determination result and store the accumulation result; analyzing properties of the accumulated pixels; and changing the high gradation values of the accumulated pixels that are greater than a predetermined gradation value in units of blocks based on the analysis result and outputting the changing result.

The analyzing properties may include weighting a time function according to a frequency of the pixels accumulated in units of blocks and the changing and outputting the high gradation values may include using the weighting result as the analysis result.

The analyzing properties may include calculating an average brightness of the pixels accumulated in units of blocks, and the changing and outputting the high gradation values may include using the calculation result of the average brightness of the brightness calculation unit as the analysis result.

The performing conversion for a gradation value in units of blocks may include adjusting a change range of the high gradation values greater than the predetermined gradation value based on a difference value between the consecutive image frames and a temporal retention degree of the difference value.

The performing conversion for a gradation value in units of blocks may include increasing the change range of the high gradation values greater than the predetermined gradation value when the temporal retention degree is greater than a predetermined temporal retention degree.

The performing conversion for a gradation value in units of blocks may include setting a driving time of a block from among the plurality of blocks on which the conversion for a gradation value is performed to be shortened when the high gradation value is greater than the predetermined gradation value.

According to another aspect of an exemplary embodiment, there is provided an apparatus for processing images. The method may include: dividing the image frame into block units; comparing a pixel value of previous frame data with a pixel value of current frame data in units of blocks and determining whether or not the comparison result is equal to or smaller than a reference value; accumulating pixels in which the comparison result is equal to or smaller than the reference value as a result of the determination result and store the accumulation result; analyzing properties of the accumulated pixels; and changing the high gradation values of the accumulated pixels that are greater than a predetermined gradation value in units of blocks based on the analysis result and outputting the changing result.

The analyzing properties may include weighting a time function according to a frequency of the pixels accumulated in units of blocks and the changing and outputting the high gradation values may include using the weighting result as the analysis result.

The weighting may include setting a weight value to be higher as the frequency becomes larger.

The analyzing properties may include calculating an average brightness of the pixels accumulated in units of blocks, and the changing and outputting the high gradation values may include using the calculation result of the average brightness of the brightness calculation unit as the analysis result.

The changing and outputting the high gradation values may include adjusting a change range of the high gradation values greater than the predetermined gradation value based on a difference value between the consecutive image frames and a temporal retention degree of the difference value.

The changing and outputting the high gradation values may include increasing the change range of the high gradation values greater than the predetermined gradation value when the temporal retention degree is greater than a predetermined temporal retention degree.

Additional aspects and advantages of the exemplary embodiments will be set forth in the detailed description, will be obvious from the detailed description, or may be learned by practicing the exemplary embodiments.

### BRIEF DESCRIPTION OF THE DRAWING FIGURES

The above and/or other aspects will be more apparent by describing in detail exemplary embodiments, with reference to the accompanying drawings, in which:

FIG. 1 is a block diagram illustrating a configuration of an image display apparatus according to an exemplary embodiment;

FIG. 2 is a block diagram illustrating a configuration of an image display apparatus according to another aspect of an exemplary embodiment;

FIG. 3 is a view illustrating a driving timing of the image display apparatus of FIG. 2;

FIG. 4 is an illustrative view illustrating a detailed configuration of a pixel unit of FIG. 2;

FIG. 5 is a graph illustrating a correlation between a driving voltage and a current flowing in a light-emitting element;

FIG. 6 is a graph illustrating a luminance error between 8-bit gamma and 10-bit gamma;

FIGS. 7A and 7B are views illustrating luminance characteristics of a main frame and a sub frame;

FIG. 8 is a flowchart illustrating an image display method according to an exemplary embodiment; and

FIG. 9 is a schematic view illustrating an image display method according to another aspect of an exemplary embodiment;

FIG. 10 is a flowchart illustrating an image display method according to another aspect of an exemplary embodiment;

FIG. 11 is a block diagram illustrating a configuration of an image display apparatus according to an exemplary embodiment;

FIG. 12 is a block diagram illustrating a configuration of an image display apparatus according to another aspect of an exemplary embodiment;

FIG. 13 is a view illustrating a driving timing of the image display apparatus of FIG. 12;

FIG. 14 is a view illustrating a detailed configuration of an image processor of FIG. 12;

FIG. 15 is a graph illustrating a weight characteristic by a time function;

FIG. 16 is an illustrative view illustrating a detailed configuration of a pixel unit of FIG. 12;

FIG. 17 is a flowchart illustrating an image display method according to a an exemplary embodiment; and

FIG. 18 is a schematic view illustrating an image display method according to another aspect of an exemplary embodiment;

FIG. 19 is a flowchart illustrating an image display method according to another aspect of an exemplary embodiment; and

FIG. 20 is a flowchart illustrating an image conversion method according to an exemplary embodiment.

### DETAILED DESCRIPTION OF THE EXEMPLARY EMBODIMENTS

Hereinafter, exemplary embodiments will be described in greater detail with reference to the accompanying drawings.

In the following description, same reference numerals are used for the same elements when they are depicted in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, functions or elements known in the related art are not described in detail since they would obscure the exemplary embodiments with unnecessary detail.

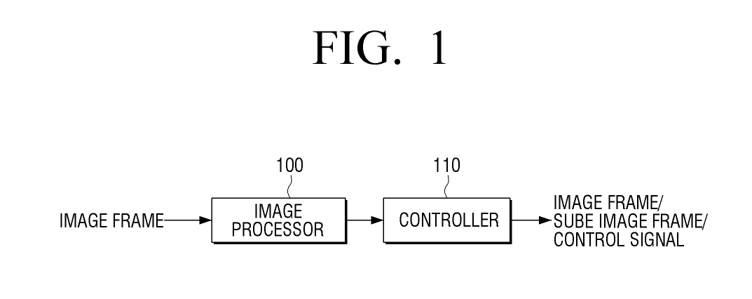

FIG. 1 is a block diagram illustrating a configuration of an image display apparatus according to an exemplary embodiment.

As shown in FIG. 1, an image display apparatus according to an exemplary embodiment includes an image processor 100 and a controller 110.

Here, the image processor 100 converts pixel data values of an input image frame, that is, pixel values and generates a sub image frame. Thus, the image processor 100 may generate a sub image frame with respect to an input image frame of 8 bits or more without separation bit conversion. However, the image processor 100 may convert an image frame of 10 bits or more into an 8-bit image frame, sets the converted 8-bit image frame as a main frame, generates a sub frame having the same content as the main frame and a different gradation expression from the main frame, and outputs the generated sub frame.

The sub frame may be generated through two methods. A first method determines, as a pixel data value of a sub image frame, the remaining pixel data value obtained by subtracting a gradation value of an input data from a maximum gradation value which can be represented by data of the input image frame. For example, when gradation which can be expressed by 8-bit data with a maximum value of 255 (a total number of values of 256 including “0”), and gradation of the input data is 240, the pixel data value of the sub image frame is 255−240=15 (total number of values). The exemplary embodiment represents that this is a complementary relation. A second method determines a pixel data value of a sub image frame to reflect an error luminance value between an ideal luminance (or target luminance) of input pixel data and real luminance displayed through a display panel (or real luminance). Thus, for example, the other method determines pixel data corresponding to adjacent input data 11 with respect to input data 14 as the pixel data value.

Further, the image process 100 may determine a display time of the input image frame and the sub image frame, that is, an emission time for implementing an image on a screen. In the first method, the sub image frame has to be smaller than the display time of the image frame. The sub image frame may be determined to be a predetermined multiple or less such 1/16. In the second method, it is possible to adjust a gamma value in addition to the display time. Therefore, the exemplary embodiment does not particularly limit how to determine the display time.

The controller 110 may output the image frame and the sub image frame provided from the image processor 100, and further generate a control and output the control signal. The control signal is a display time in which the image frame and the sub image frame are implemented as an image in a display panel and for example, the controller 110 may be generate and output the control signal according to information provided from the image processor 100.

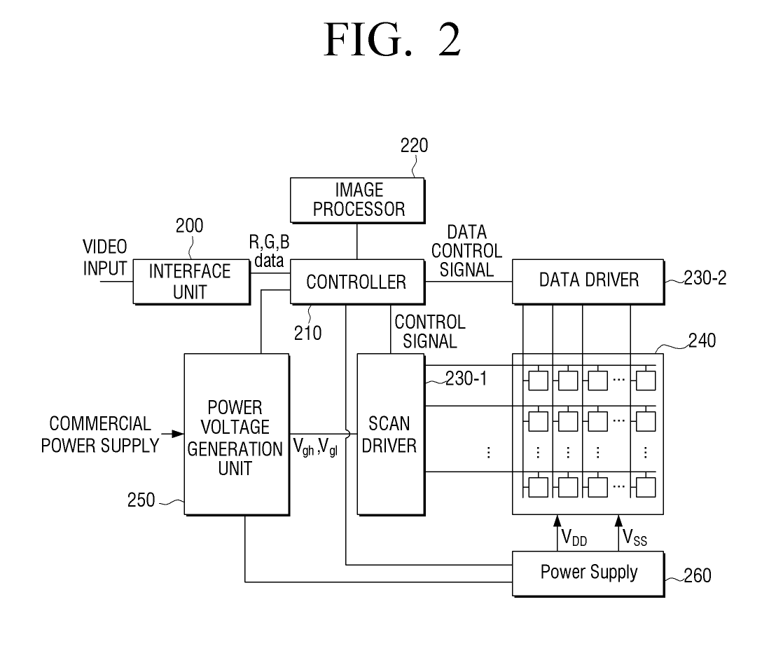

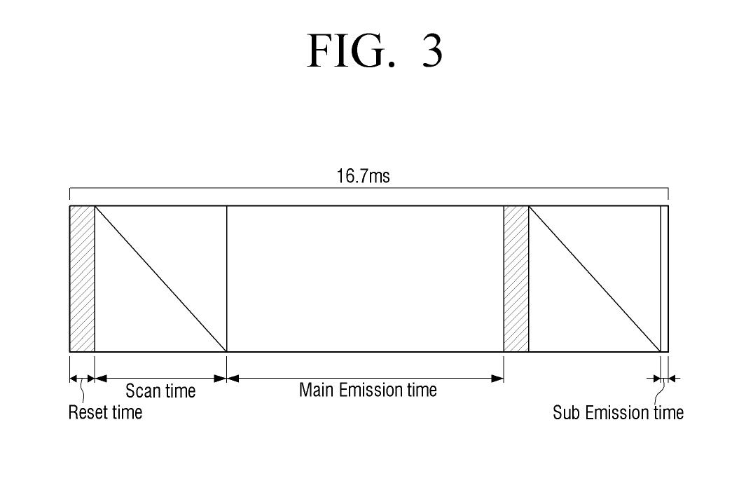

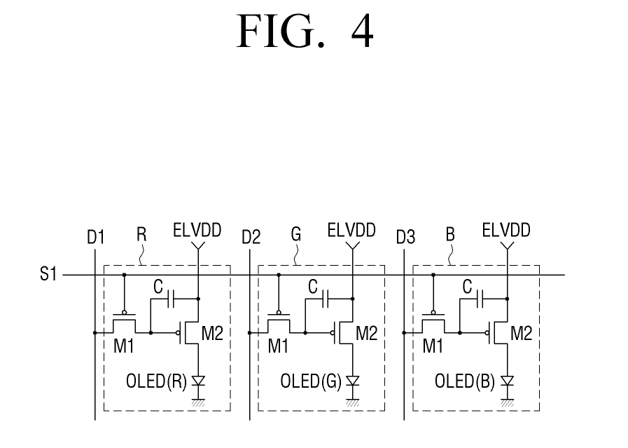

FIG. 2 is a block diagram illustrating a configuration of an image display apparatus according to another aspect of an exemplary embodiment, FIG. 3 is a driving timing diagram of the image display apparatus of FIG. 2, and FIG. 4 is an illustrative view illustrating a detailed configuration of a pixel unit of FIG. 2.

As shown in FIG. 2, an image display apparatus according to this exemplary embodiment wholly or partially include an interface unit 200 (e.g., an interface), a controller 210, an image processor 220, a scan driver 230_1, a data driver 230_2, a display panel 240, a power voltage generation unit 250 (e.g., a voltage generator), and a power supply unit 260 (e.g., a power supply).

The interface unit 200 is an image board such as a graphic card and coverts image data input from an outside source to image data suitable for a resolution of the image display apparatus and output the converted image data. Here, the image data may be configured of Red (R), Green (G), and Blue (B) image data of 8 bit or more. The interface unit 200 generates a clock signal (DCLK) and control signals such as a vertical synchronous signal (Vsync) and a horizontal synchronous signal (Hsync). Then, the interface unit 200 provides the vertical and horizontal synchronous signals Vsync and Hsync and image data to the controller 210.

The controller 210 outputs a sub frame (or a sub image frame) with respect to a unit frame image of input R, G, and B data. When the controller 210 generates image data according to bit conversion as a main frame, the controller 210 provides the generated main frame to the image processor 220, receives a sub frame generated based on the main frame, and outputs the sub frame. In this case, as shown in FIG. 3, the controller 210 divides the period of time for displaying image data of the unit frame, that is, 16.7 ms to insert sub frame data and simultaneously adjusts an emission time of the inserted sub frame. Here, the inserted sub frame data may be frame included in the same image as the main frame and represented with different gradation from the main frame. The sub frame data is R, G, and B image data and is generated by changing input R, G, and B image data according to a design rule of a system to be image sticking-compensated data and low gradation-compensated data. At this time, the image sticking-compensated data is output with low gradation which has a complementary relation when input gradation is high gradation. The low gradation-compensated data is a data compensated by adjusting an emission time of the sub frame and further gamma are adjusted so that an error between ideal luminance (that is, error-free luminance) and displayed luminance becomes display luminance of the sub frame and outputting data closest to the error.

For example, the controller 210 may rearrange R, G, and B data from the interface unit 200 from 10-bit data to 8-bit data, first provide the rearranged data as data for the main frame to the data driver 230_2, and then generate luminance error-compensated data based on the 8-bit data and provide the generated sub frame data to the data driver 230_2 again. At this time, the generation of the sub frame is performed under interworking with the image processor 220. For example, when the sub frame is generated to improve low gradation reproduction using sub frame, a system designer may measure error luminance between ideal luminance and experiential luminance, that is, luminance displayed in a display unit based on gamma 2.2 luminance characteristic in which maximum luminance is 200 cd/cm². When gradation data based on the error luminance calculated described above has been stored and main frame data with specific gradation is provided, the gradation data matched with the main frame data is provided to the sub frame. At this time, luminance information may be also provided so that the emission time may be adjusted. Detailed description thereof will be described later.

Further, when the controller 210 generates the main frame according to bit conversion with respect to the input R, G, and B unit frame, the controller 210 generates a control signal for controlling the scan driver 230_1 and the data driver 230_2 to allow main frame data and sub frame data to be displayed on the display panel 240. That is, the controller 210 receives the vertical and horizontal synchronous signals from the interface 200, generates a timing control signal for scanning the input R, G, and B data in a main frame scan time and a signal for controlling an emission time of the main frame, and generates a timing control signal for scanning the calculated sub frame data in a sub frame scan time and a signal for controlling an emission time of the sub frame. The above-described operation is illustrated in FIG. 3. Here, the signal for controlling the emission time may be referred to as a data signal for allowing the main frame data and the sub frame data to be output from the data driver 230_2 to the display panel 240.

The R, G, and B data of the main frame and sub frame converted through the controller 210 may represent gradation information of the R, G, and B data by a logic voltage V_{log} provided from the power voltage generation unit 250. The controller 210 may generate a gate shift clock (GSC), a gate output enable (GOE), a gate start pulse (GSP), and the like as a gate control signal for controlling the scan-driver 230_1. Here, the GSC is a signal for determining an On/Off time of a gate of a thin film transistor (TFT) connected to a light-emitting element such as R, G, and B OLED. The GOE is a control signal for controlling an output of the scan driver 230_1. The GSP is a signal for notifying a first driving line of a screen in one vertical synchronous signal. Further, the controller 210 may generate a source sampling clock (SSC), a source output enable (SOE), a source start pulse (SSP), and the like as a data control signal. Here, the SSC is used as a sampling clock for latching data in the data driver 230_2 and determines a driving frequency of a data driver IC. The SOE allows data latched by the SSC to be transmitted to the display panel. The SSP is a signal for notifying latching start or sampling start of data in one horizontal synchronous signal.

Although not shown, the controller 210 according to an exemplary embodiment may include a control signal generation unit and a data rearrangement unit (e.g., a data rearrangement device) to perform the above-described functions. Here, the control signal generation unit may generate a gate control signal and a data control signal for the main frame and the sub frame within one unit frame period and provide the gate control signal and the data control signal to the scan driver (230_1) and the data driver (230_2), respectively. For example, when the period of time for displaying an image of the unit frame is 16.7 ms, the main frame and sub frame for the unit frame image have to be consecutively displayed within the corresponding period of time. When it is assumed that the controller 210 processes data for the sub frame while interworked with the image processor 220, the data rearrangement unit may form and process only data of the main frame.

When it is assumed that the image processor 220 interworks with the controller 210 and the controller 210 rearranges input R, G, and B data to form data of the main frame data, the image processor 220 may generate data of the sub frame with respect to a corresponding main frame and provide the generated data of the sub frame. At this time, the image processor 220 may provide information for controlling an emission time of the sub frame together with the data. Thus, the image processor 220 may store the data of the sub frame matched with the input data of the main frame in a look-up table (LUT) form in the memory unit according to a design rule. In this regard, the image processor 220 according to an exemplary embodiment may generate the data of the sub frame by two rules. In other words, the first method generates data having the complementary relation with the data of the main frame as the data of the sub frame. For example, when data “240” is provided, since 8-bit data enables representation of 256 gradations, the image processor generates data “15” which is obtained by subtracting the value of “240” from the value of 255 “255” as the data of the sub frame. The system designer predetermines the luminance error between ideal luminance for specific gradation data and the real displayed luminance. Therefore, the second method stores the sub frame data in which the luminance error is reflected with respect to the main frame data and outputs corresponding data as the sub frame data. At this time, the emission time of the sub frame and further adjustment of the gamma value has been previously set by the system designer or are determined by analyzing the sub frame data.

The image processor 220 may sequentially store the main frame data and the sub frame data for the unit frame image under control of the controller 210 and then sequentially output the main frame data and the sub frame data by request of the controller 210. Thereby, the controller 210 may provide the main frame data and sub frame data to the data driver 230_2 within the preset time so that the unit frame image may be displayed in the display panel.

The scan driver 230_1 receives gate on/off voltages V_{gh}/V_{gl} provided from the power voltage generation unit 250 and provides corresponding voltages to the display panel 240 under the control of the controller 210. The gate on voltage V_{gh} is sequentially provided from a first gate line GL₁ to an n-th gate line GLₙ to implement the unit frame image on the display panel 240. At this time, the scan driver 230_1 operates in response to a gate signal for the main frame and a gate signal for the sub frame data generated in the controller 210 according to an exemplary embodiment. The above-described operation is illustrated in FIG. 2.

The data driver 230_2 converts R, G, and B image data, which are digital serial data provided from the controller 210, into analog parallel image data, that is, analog voltages, and simultaneously provides analog image data corresponding to one horizontal line to the display panel in a sequential manner for the horizontal lines. For example, the image data provided from the controller may be provided to a digital to analog converter (DAC) in the data driver 230_2. At this time, digital information of the image data provided to the D/A converter is converted into analog voltage for representing color gradation and then provided to the display panel 240. The data driver 230-2 is also synchronized with the gate signals for the main frame and the sub frame provided to the scan driver 230_1 to output the main frame data and the sub frame data.

In the display panel 240, a plurality of gate lines GL₁ to GLₙ and a plurality of data lines DL₁ to DLₙ, which cross each other and define pixel areas, are formed, and R, G, and B light-emitting elements such as OLEDs are formed in each of the pixel areas at interconnections of the gate lines and data lines. A switching element, that is, a thin film transistor (TFT) is formed in a portion of each of the pixel areas, specifically, a corner of the pixel area. The gradation voltages from the data driver 230_2 are provided to the R, G, and B light-emitting elements. At this time, the R, G, and B light-emitting elements emit light corresponding to current amounts provided according to variations of the gradation voltages. That is, when a large amount of current is applied, the R, G, and B light-emitting elements provide light having large intensity corresponding to the large amount of current. As shown in FIG. 4, each of the R, G, and B pixel units may include a switching element M1 configured to operate in response to a gate signal S1 provided from the controller 210, that is, the gate on voltage V_{gh}, and a switching element M2 configured to provide a current corresponding to each of the R, G, and B pixel values of the main frame and sub frame provided to the data lines DL1 to DLn when the switching element M1 is turned.

The power voltage generation unit 250 receives commercial power, that is, alternating current of 110V or 220 V, from the outside to generate various levels of a direct current (DC) voltage, and output the generated DC voltage. For example, the power voltage generation unit 250 may generate a voltage of DC 12 V for gradation representation and provide the generated voltage to the controller 210. Alternatively, the power voltage generation unit 250 may generate the gate on voltage V_{gh}, for example a DC voltage of 15 V, and provide the generated voltage to the scan driver 230_1. Further, the power voltage generation unit 260 may generate a DC voltage of 24 V and provide the generated voltage to the power supply unit 260.

The power supply unit 260 may receive the voltage provided from the power voltage generation unit 250 to generate a power voltage V_{DD} required for the display panel 240 and generate the generated power voltage or provide a ground voltage V_{SS}. For example, the power supply unit 260 may receive a voltage of DC 24V from the power voltage generation unit 250, generate a plurality of power voltages V_{DD}, select a specific power voltage under control of the controller 210, and provide a selected power voltage to the display panel 240. Thus, the power supply unit 260 may further switch elements configured to provide the selected specific voltage under control of the controller 210.

As described above, the image display apparatus according to an exemplary embodiment, the scan driver 230_1 or the data driver 230_2 may be mounted on the display panel 240, the power supply unit 260 may be integrally configured with the power voltage generation unit 250, and the power supply unit 260 may simultaneously perform a function of the image processor in data rearrangement. Therefore, the exemplary embodiment is not particularly limited to the combination or separation of components.

The exemplary embodiment prevents image sticking and improves low expressiveness through the above configuration so that image quality of the image display apparatus using OLED, for example, can be improved and lifespan of the panel can be extended.

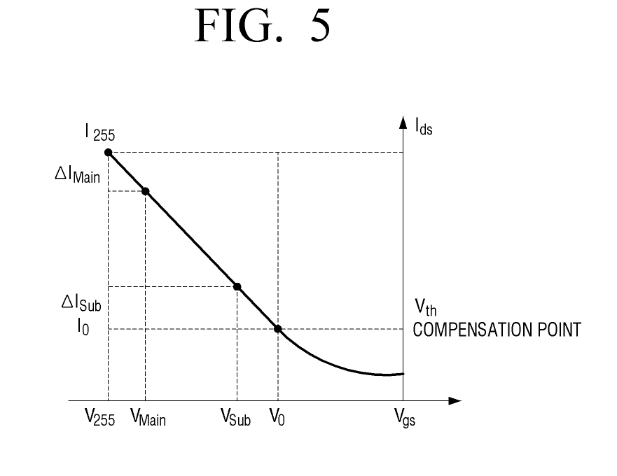

FIG. 5 is a graph showing a correlation between a driving voltage and a current flowing in a light-emitting element.

The image display apparatus according to an exemplary embodiment uses a method of calculating image sticking compensation data to remove image sticking using a sub frame.

In FIG. 5, I₂₅₅ denotes a current flowing in a light-emitting element such as OLED when input data is maximum value, that is, 255 based on 8 bit data, and I₀ denotes a current flowing in the light-emitting element such as OLED when input data is a minimum value, that is, 0 based on 8 bit data. As shown in FIG. 5, the current is linearly proportional to the voltage and the voltage is proportional to the input data. That is, it can be seen that as the input data is high gradation data, an overcurrent flows in the light-emitting element.

For example, when the input gradation is a Vₘₐᵢₙ voltage containing a high gradation group, that is, data “240”, the compensation data becomes data in which a low current flows such as a voltage (V_{sub}=Vₘₐₓ−Vₘₐᵢₙ) by the data inserted into the sub frame, that is, the data “15” so that current reverse compensation is obtained every frame. In addition, in the exemplary embodiment, as shown in FIG. 3, the emission time of the sub frame is controlled to be predetermined multiple times less than the emission time of the main frame to minimize an effect of luminance of the compensation data on gradation expression of the input original image.

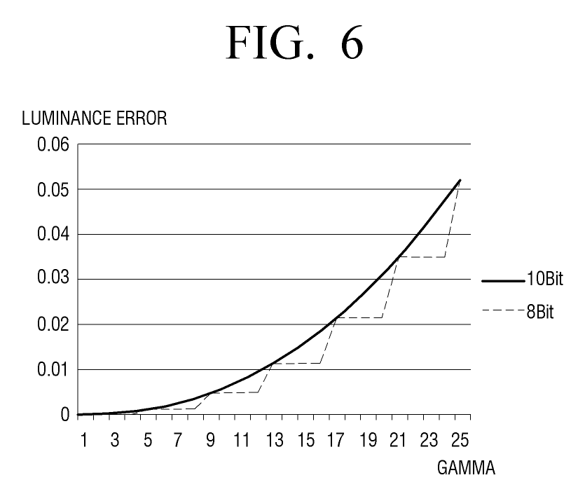

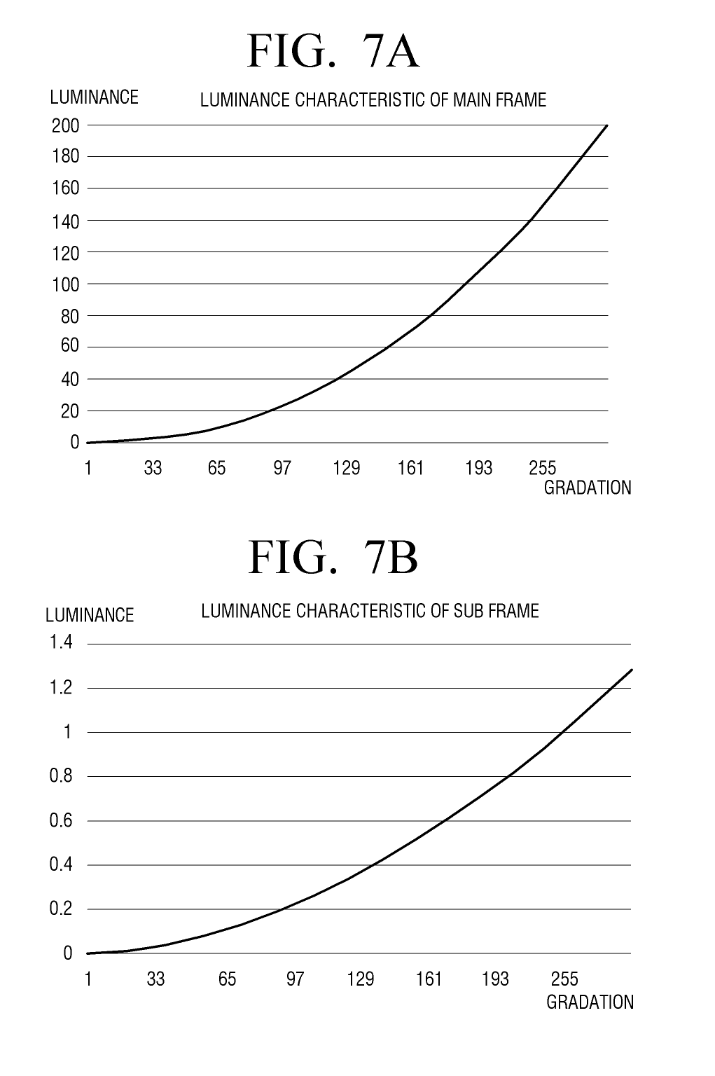

FIG. 6 is a graph showing luminance errors of 8-bit gamma and 10-bit gamma and FIGS. 7A and 7B are views showing luminance characteristics of the main frame and the sub frame.

The image display apparatus according to an exemplary embodiment may use a method of calculating low-gradation compensation data using the sub frame to improve low-gradation reproduction.

FIG. 6 illustrates a graph showing a low gradation area of real data in which maximum luminance is 200 cd/m², and a luminance characteristic of gamma 2.2 and a low gradation area of an ideal having a luminance characteristic of gamma 2.2. It can be seen that when the input gradation is 14, the ideal luminance is 0.158 cd/m², but the displayed luminance is 0.0112 cd/m², and thus the luminance error of 0.0045 cd/m² occurs. Although the luminance error is considered to be small, when the human visual characteristic sensitive to luminance variation in the low gradation area and the visual environment such as a dark light are considered, the luminance error is significantly recognized by eyes of the human.

Thus, in the exemplary embodiment, the luminance error is compensated by inserting data corresponding to the luminance error between the ideal luminance desired by the designer and the real luminance displayed in the image display apparatus into the sub frame. It can be seen from FIGS. 7A and 7B that when the maximum luminance of the main frame 200 cd/cm², the maximum error and the minimum error between the ideal luminance and real displayed luminance become 1.28 cd/m², and 0.00022 cd/m², respectively.

For the low gradation compensation, the exemplary embodiment adjusts the emission time to cause the maximum luminance of the sub frame to be the maximum luminance error of the main frame of 1.28 cd/m² and readjusts the gamma value of the sub frame to 1.8 so that the minimum luminance of the sub frame is approximate to the minimum luminance error of the main frame of 0.00022 cd/m². For example, when the main frame data is “14”, since the luminance error becomes 0.0045 cd/m², the sub frame data 11 closest thereto is calculated as the compensation data and the luminance error is removed based on the compensation data. In the low gradation compensation method according to the above-described exemplary embodiment, the emission time and the gamma value may be changed according to the emission time of the main frame, that is, the maximum luminance.

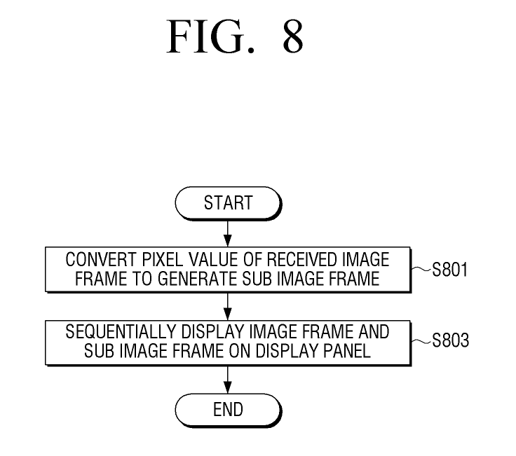

FIG. 8 is a flowchart illustrating an image display method according to an exemplary embodiment.

For clarity, referring to FIG. 8 together with FIG. 1, the image display apparatus according to an exemplary embodiment converts a pixel data value of a received image frame, that is, the pixel value to generate sub image frame (S801). Here, the sub image frame may have the same contents as and a different gradation expression from the input image frame. The contents of the sub image frame are fully described above and detailed description thereof will be omitted.

After the image display apparatus generates the sub image frame, the image display apparatus sequentially displays the image frame and the sub image frame on the display panel (S803). For example, assuming that the period of time for the display panel to display the unit frame takes 16.7 ms, the image display apparatus of the exemplary embodiment displays the image frame and the sub image frame within 16.7 ms. At this time, a display time of the sub image frame is smaller than that of the image frame. The sub image frame may be displayed within the predetermined multiple times or less (for example, 1/16) of the display time of the image frame. The display method is fully described above and thus the detailed description thereof will be omitted.

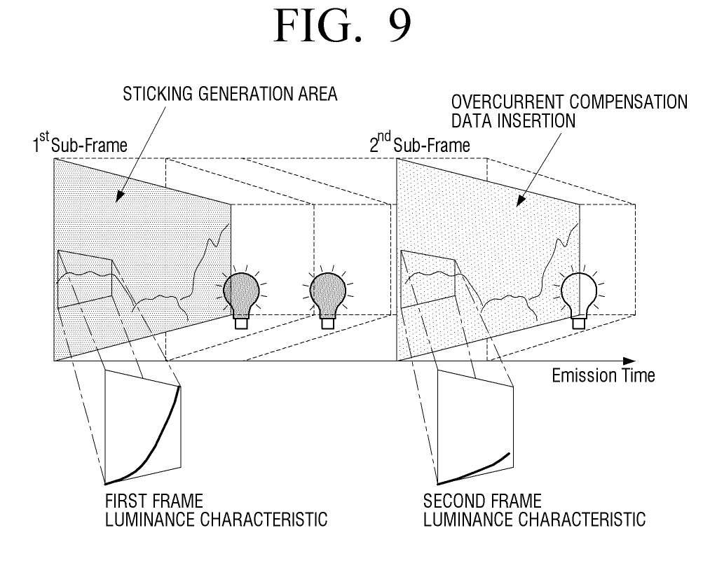

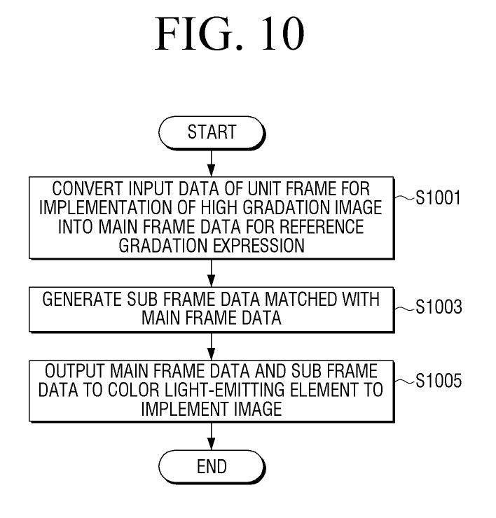

FIG. 9 is a schematic diagram illustrating an image display method according to another aspect of an exemplary embodiment and FIG. 10 is a flowchart illustrating an image display method according to another aspect of an exemplary embodiment.

For clarity, referring to FIGS. 9 and 10 together with FIG. 2, the image display method according to this exemplary embodiment divides a time for display an image data of a unit frame, and inserts data of the sub frame into the divided display time and simultaneously controls an emission time of the inserted sub frame.

More specifically, the image display apparatus converts input data of a unit frame, which enables implementation for a high gradation image, as 10-bit R, G, and B data into data of a main frame expressible with preset reference gradation (S1001). For example, the controller 110 of FIG. 1 may receive 10-bit R, G, and B image data and generate image data of the main frame in which the 10-bit R, G, and B image data is bit-converted into 8-bit R, G, and B data. However, this exemplary embodiment may use the input data as the image data of the main frame and thus is not particularly limited to the above-described bit conversion.

Next, the image display apparatus generates data of the sub frame matched with the input main frame (S1003). At this time, data to be inserted into the sub frame may be different depending on the designer's purpose, that is, depending on the removal of image sticking or the improvement of low gradation reproduction. Data having a complementary relation with the main frame data is inserted as the sub frame data to remove the image sticking. In other words, for data “240”, data “15” having a complementary relation with the data “240” is inserted on the basis of 8-bit 256 gradations. Data for compensation of luminance error between the ideal luminance and the displayed luminance is inserted as the sub frame data to improve the low gradation reproduction. The emission time for the sub frame in which the data having the complementary relation is inserted or the data for luminance error compensation is inserted can be adjusted. In the case of luminance error compensation, the gamma value may be also adjusted. The generation of the sub frame data has been fully described above and thus detailed description thereof will be omitted.

Subsequently, the image display apparatus emits the light-emitting elements according to the main frame data and the sub frame data to implement the image (S1005). In other words, the R, G, and B color light-emitting elements formed in the display panel 240 of FIG. 2 may first receive the main frame data, for example, during the unit frame period of 16.7 ms. Then, after the main frame data is reset, the R, G, and B color light-emitting elements may receive the sub frame data and consecutively emit light to implement the image.

According to an exemplary embodiment, the image display method can overcome the image sticking and improve the low gradation reproduction. Therefore, the picture quality of the image display apparatus such as an OLED can be improved and the lifespan of the image display apparatus can be extended.

Although the image display method according to an exemplary embodiment has been embodied in the display apparatus having the above-described configuration illustrated in FIG. 2, the image display method may also be embodied in an image display apparatus having other configurations. Therefore, the image display method according to the exemplary embodiment is not limited to be embodied in the image display apparatus described above.

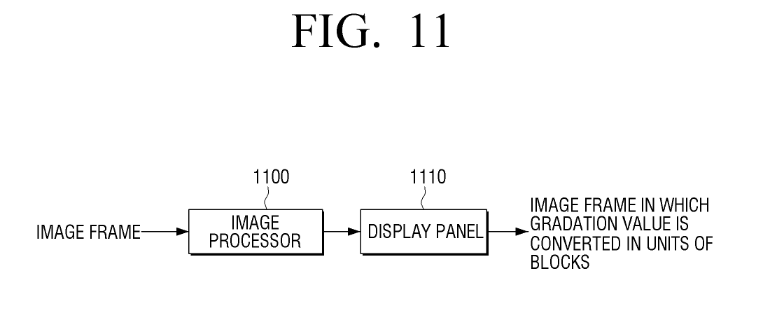

FIG. 11 is a block diagram illustrating an image display apparatus according to an exemplary embodiment.

As shown in FIG. 11, an image display apparatus according to the second exemplary embodiment includes an image processor 1100 and a display panel 1110.

Here, the image processor 1100 compares input image frames, for example, a previous image frame and a current image frame to determine whether or not consecutive image frames including blocks having a gradation value within a preset range. When it is determined that the consecutive image frames are preset, the image processor converts a gradation value in units of blocks and outputs the conversion result. For example, the image processor 1100 may compare a pixel data value of the previous image frame and a pixel data value of the current image frame in units of blocks, store pixels having a reference value or a constant value or less, calculate temporal variations of the stored pixels and further brightness thereof to convert gradation values within a preset range, such as high gradation values, and output the conversion result. Further, the image processor 1100 may output information such as coordination values for blocks including the converted high gradation values to adjust the display time of the blocks.

The display panel 1110 displays an image frame including the converted gradation values on a screen under the control of the controller (not shown). In other words, the display panel 1110 may differently operate for the blocks with respect to the image frame. At this time, a gradation voltage corresponding to a gradation value converted in a specific block, such as a gradation value in which the high gradation value is reduced is provided to the display panel 1110, but the display panel 1110 may compensate the reduced amount by adjusting an emission time, that is, a displayed time of the image frame by the reduced gradation value.

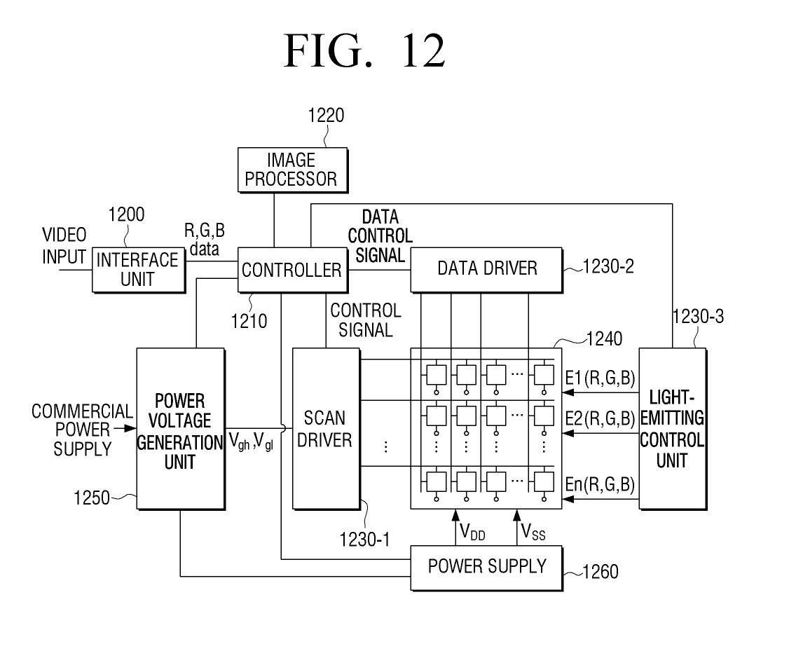

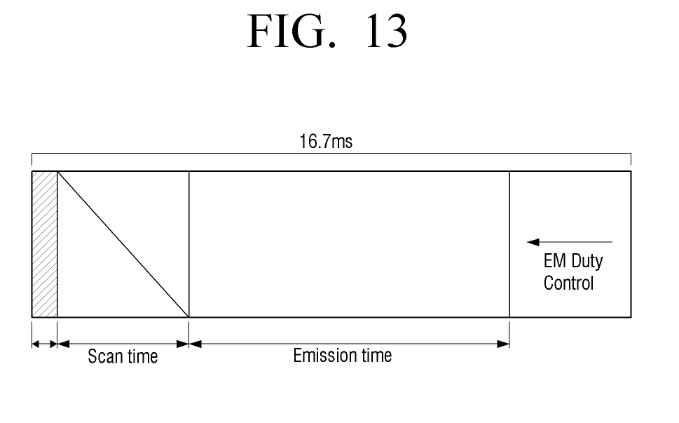

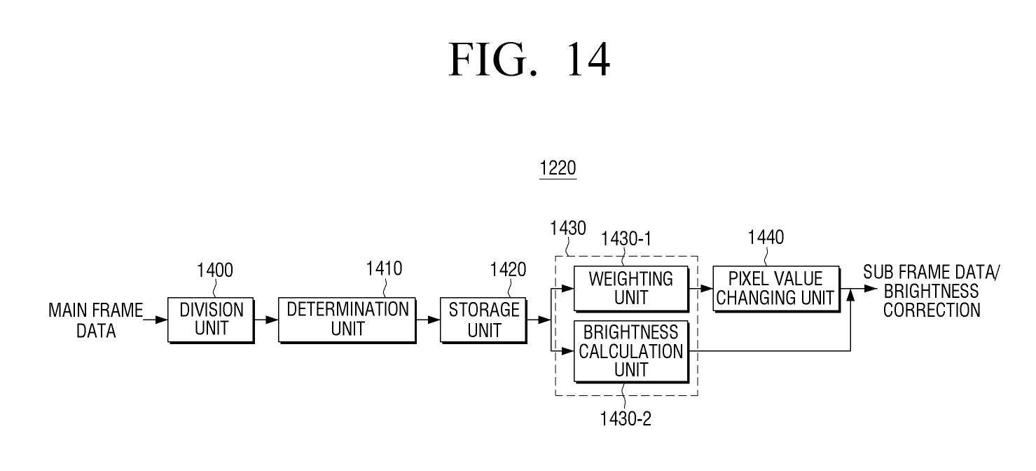

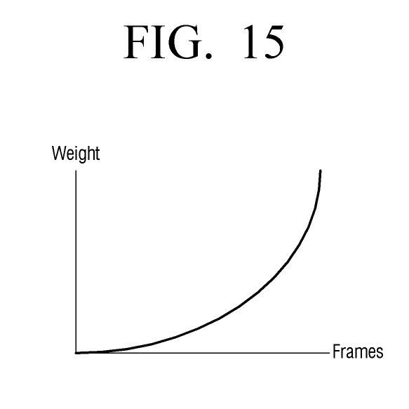

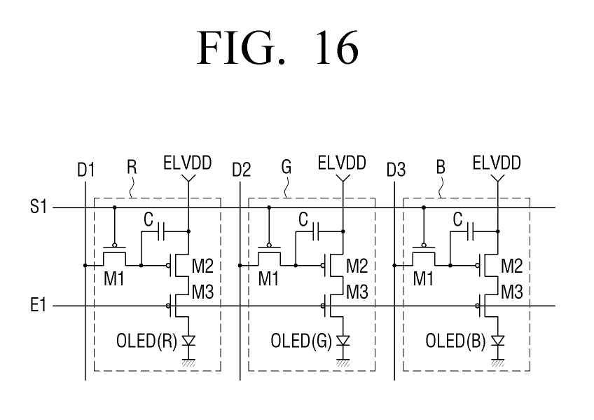

FIG. 12 is a block diagram illustrating a configuration of an image display apparatus according to another aspect of an exemplary embodiment, FIG. 13 is a view illustrating a driving timing of the image display apparatus of FIG. 12, and FIG. 14 is a view illustrating a detailed configuration of an image processor. Further, FIG. 15 is a graph illustrating a weight characteristic by a time function, and FIG. 16 is an illustrative view illustrating a detailed configuration of a pixel unit of FIG. 2.

As shown in FIG. 12, the image display apparatus according to this exemplary embodiment partially or wholly includes an interface unit 1200 (e.g., an interface), a controller 1210, an image processor 1220, a scan driver 1230_1, a data driver 1230_2, a light-emitting control unit 1230_3 (e.g., a light controller), a display panel 1240, a power voltage generation unit 1250 (e.g., a voltage generator), a power supply unit 1260 (e.g., a power supply), and a frame storage unit (not shown) (e.g., frame storage).

Here, the controller 1210 may receive vertical/horizontal synchronous signals from the interface unit 1200 to generate a gate control signal for controlling the scan driver 1230_1 and a data control signal for controlling the data driver 1230_2. Further, the controller 1210 may rearrange 10-bit R, G, and B data from the interface unit 1200 into 8-bit R, G, and B data and provide the rearrangement result to the data driver 1320_2. Therefore, the controller 1210 may further comprise a control signal generation unit (e.g., a control signal generator) configured to generate a control signal and a data rearrangement device configured to rearrange data. The R, G, and B data rearranged in the controller 1210 may be set to be corresponding to gradation information of the R, G, and B data by a logic voltage provided from the power voltage generation unit 1250.

Further, the controller 1210 interworks with the image processor 1220 and the light-emitting control unit 1230_3. For example, the controller 1210 may provide the pixel gradation value generated through the R, G, and B data rearrangement device to the processor 1220, cause the image processor to calculate the sticking degree for areas, and control the light-emitting control unit 1230_3 to adjust the emission time in a specific area of the display panel according to the calculated degree. For example, the image processor 1220 provides a coordinate value of a corresponding block or the like to the controller 1210, the controller 1210 may adjust a duty ratio output from the light-emitting control unit 1230_3 based on the coordinate value to adjust an emission time (or display time) of the specific area of the display panel 1240 as shown in FIG. 13. In other words, the controller 1210 may increase the emission time by the reduced high gradation value of a specific pixel with respect to each of the blocks to compensate the luminance. At this time, the emission time may be adjusted based on a cumulative physical amount of pixels with respect to the temporal variation for blocks and the cumulative physical amount is inversely proportional to the emission time. That is, as the cumulative physical amount is large, the emission time may be set to be short.

The image processor 1220 may divide image data of the unit frame provided from the controller 1210 into a plurality of blocks, compare data for blocks in a previous frame and data for blocks in a current frame, calculate the sticking degree based on characteristics of cumulative pixels by the comparison result, and control maximum gradation data usable for blocks according to the sticking degree and simultaneously adjust the emission time of the display panel 1240 based on a cumulative value of the sticking degree in the frame calculated for the blocks. At this time, to calculate the sticking degree, the image processor 1220 may calculate the sticking degree of an image for the blocks for a constant period of time or calculate the sticking degree through analysis of average brightness.

For example, the image processor 1220 may receive the image data of the unit frame from the controller 1210, divide the image data of the unit frame into the plurality of blocks, accumulate the pixels in which a difference between data of the previous frame and data of the current frame is equal to or less than a threshold value (or reference value) in each of the blocks, weight a time function to a frequency cumulated for blocks to calculate the weighting result and to calculate average brightness of the cumulative pixels, and change peak gradation values for blocks and provide the changed gradation value to the controller 1210, and simultaneously further provide information for the emission time to the controller 1210. At this time, the image processor 1220 may use the difference between the pixel gradation value of the data of the previous frame and the pixel gradation value of the data of the current frame. For example, when the threshold value is set to be “5”, the pixel gradation value of the data of the previous frame is “240”, and the pixel gradation value of the data of the current frame is “239”, since the difference between the previous frame and the current frame gradation is smaller than the threshold value of “5”, a corresponding pixel may be a target in which the pixel value is to be changed according to the temporal variation amount, that is, the cumulative value of the frame.

Here, the temporal variation amount is a temporal variation amount of image data in each area of the divided areas and may be calculated based on the difference value between data of the consecutive frames and a temporal retention degree of the difference value. The image data in each area of the divided areas may be adjusted so that maximum data value of the image data is to be equal to or less than a predetermined value when the calculated temporal change rate is small, the image data in each area of the divided area may be adjusted so that the maximum data value of the image data is to be equal to or more than the predetermined value when the calculated temporal change rate is large. In other words, as a degree of the temporal change rate increases, a magnitude of the change rate of the maximum data value of the image data can be adjusted.

To perform the above-described function, as shown in FIG. 14, the image processor 1220 may partially or wholly include a division unit 1400 (e.g., an image divider) configured to divide the input image data into the plurality of blocks, a determination unit 1410 (e.g., a frame comparison device, a frame comparer, etc.) configured to compare consecutive frames, that is, data of the previous frame and data of the current image data to determine whether or not a data difference between consecutive frames for the blocks is equal to or less than the threshold value, a storage unit 1420 (e.g., a storage) configured to store pixels for the blocks when it is determined that the data difference is equal to or less than the threshold value, a weighting unit 1430_1 (e.g., a time function weighting device) configured to weight a time function to a frequency cumulated for the blocks, a brightness calculation unit 1430_2 (e.g., a brightness calculator) configured to calculate brightness of the pixels cumulated for the blocks and output the calculation result, and the pixel value change unit 1440 (e.g., a pixel value adjuster) configured to change the peak gradation value according to the weight value and output the changed result. At this time, the weighting unit 1430_1 and the brightness calculation analyze arbitrary properties such as temporal change rate and brightness using the cumulative pixels and thus may be referred to as a property analysis unit 1430 (e.g., a property analyzer).

Here, as shown in FIG. 15, the weighting unit 1430_1 may improve accuracy for calculation of the sticking degree by reducing the calculated sticking degree when there is no difference in the frame data for less than a predetermined time and by increasing the sticking degree when there is the data difference for a period greater than the predetermined time. The pixel value changing unit 1440 (e.g., a pixel value adjuster) changes a contrast curve corresponding to each of the blocks according to the sticking degree calculated for the blocks by the weighting unit 1430_1. In other words, the pixel value changing unit 1440 may reduce high gradation on the contrast curve in the sticking generation area to allow the current flowing in a color light-emitting element to be lowered, while the pixel value changing unit 1440 does not adjust the high gradation on the contrast curve in the non-sticking generation area due to the low sticking degree. Since an adjustment range is limited when the high gradation for blocks is adjusted, the emission time corresponding to the shortage may be adjusted to restrict the current amount in units of frames. Here, for example, the limit of the adjustment range denotes that the high gradation is excessively adjusted and thus luminance imbalance and the like are caused. Therefore, the emission time may be adjusted according to information provided from the brightness calculation unit 1430_2.

The scan driver 1230_1 receives the gate on/off voltage V_{gh}/V_{gl} provided from the power voltage generation unit 1250 and provides a corresponding voltage to the display panel 1240 under control of the controller 1210. The gate on voltage V_{gh} is sequentially provided from a first gate line GL₁ to an n-th gate line GLₙ to implement the unit frame image on the display panel.

The data driver 1230_2 converts digital R, G, and B image data provided from the controller 1210 in series into analog data, that is, an analog voltage in parallel and simultaneously provides image data corresponding to one horizontal line in a sequential manner every horizontal line. For example, the image data provided from the controller 1210 may be provided to a D/A converter in the data driver 1230_2. Digital information of the image data provided to the D/A converter is converted into the analog voltage which enables color gradation expression and provided to the display panel 1240.

The light-emitting control unit 1230_3 generates control signals having different duty ratios from each other under control of the controller 1210 and provides the control signals to the display panel 1240. Here, the duty ratios of the control signals may be set to be different from each other with respect to the areas of the display panel 240 or may be set to be different only with respect to specific color light-emitting elements in a specific area. Thus, the light-emitting control unit 1230_3 may include a pulse width modulation (PWM) signal generation unit. The PWM signal generation unit may generate the control signals having different duty ratios from each other for the blocks of the light-emitting element or for specific light-emitting elements under control of the controller 1210. In this case, the light-emitting 1230_3 may further include switching elements. The switching elements may operate under control of the controller 1210 to control an output period of time of the PWM signal applied to the display panel 1240. For example, the light-emitting control unit 1230_3 may control the emission times of the blocks having the changed high gradation values. The emission time is controlled so that as the temporal change rate is increases, the emission time is reduced.

The R, G, and B pixels will be described in detail with reference to FIG. 16. Each of the R, G, and B pixel units may include a switching element configured to operate by a scan signal S1, that is, the gate on voltage V_{gh}, a switching element configured to output current based on pixel values including the changed high gradation value provided to data lines DL₁ to DLₙ, and a switching element configured to control the current amount from the switching element M2 to R, G, and B light-emitting elements, specifically, the emission time according to the control signal provided from the light-emitting control unit 1230_3. Here, the R, G, and B light-emitting elements may receive control signals having different duty ratios from each other for areas or for light-emitting elements through one line, but may be designed to substantially receive the control signals for the areas through different lines that are separated from each other. However, the exemplary embodiment does not particularly limit how to form lines as long as an emission time of a light-emitting device representing the high gradation value or emission times of light-emitting elements in area including the light-emitting element can be adjusted.

Other than the above-described points, the interface unit 1200, the controller 1210, the display panel 1240, the power voltage generation unit 1250, and the voltage supply unit 1260 of the exemplary embodiment illustrated in FIG. 12 have the same contents as those of the interface unit 200, the controller 210, the display panel 240, the power voltage generation unit 250, and the power supply unit 260 of the one exemplary embodiment illustrated in FIG. 2 and thus detailed description thereof will be omitted.

The exemplary embodiments having the above-described configurations can partially control luminance of an area in which sticking occurs to prevent the sticking in advance and thus extend lifespan of the display panel as compared with the related art.

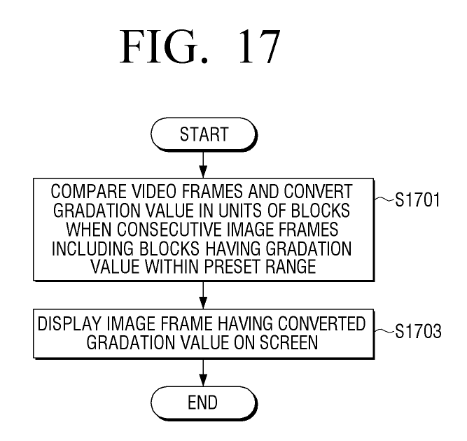

FIG. 17 is a flowchart illustrating an image display method according to an exemplary embodiment.

Referring to FIG. 17 together with FIG. 11, the image display apparatus according to the second exemplary embodiment compares input image frames and converts the gradation values for blocks when the consecutive image frames including blocks having gradation values within a preset range are present (S1701). For example, the image display apparatus compares pixel values between a previous frame and a current frame in units of blocks, accumulates and stores pixels equal to or less than a reference value as a comparison result, analyzes characteristics of the stored pixels, and converts and outputs high gradation values of a specific block according to the analysis result. At this time, the degree of conversion may be changed according to a degree of the occurrence of sticking. The other detailed contents are fully described above and thus detailed description thereof will be omitted.

Further, the display apparatus displays the image frame having the converted gradation value on a screen (S 1703). For example, when it is determined that the sticking occurs in a lower end of the screen, the image frame in which the gradation value is converted in a corresponding portion is displayed on the screen. The exemplary embodiment may drive the emission time, that is, a display time in the lower end portion by the reduced gradation value differently from the surrounding areas. The other detailed contents are fully described above and thus detailed description thereof will be omitted.

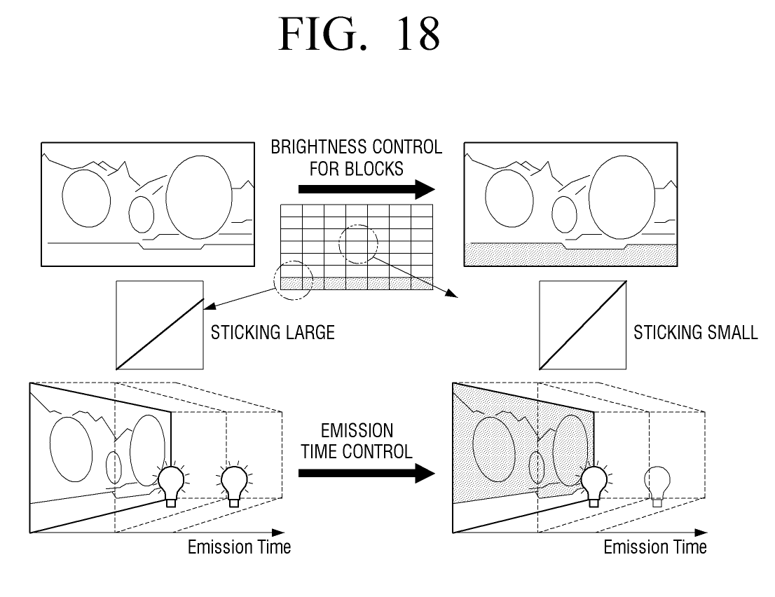

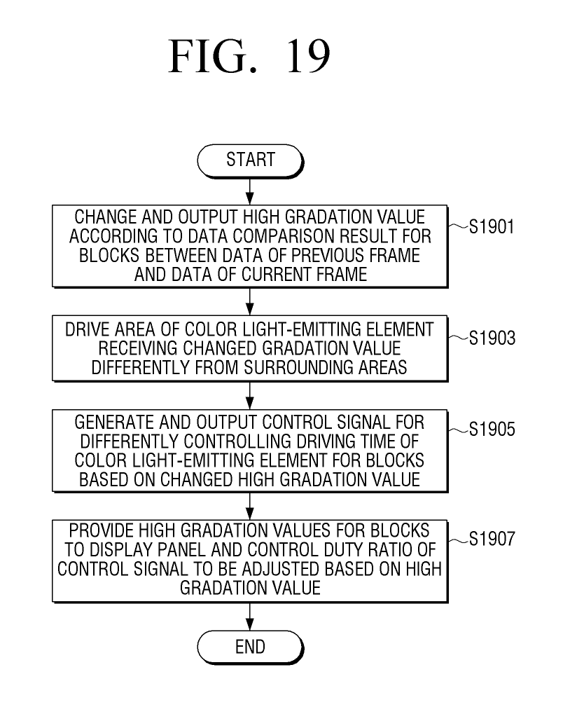

FIG. 18 is a schematic view of an image display apparatus according to an exemplary embodiment and FIG. 19 is a flowchart illustrating an image display method according to an exemplary embodiment.

Referring to FIGS. 18 and 19 together with FIG. 12, the image display apparatus according to an exemplary embodiment controls peak gradation data for blocks and simultaneously controls the emission time of the display panel 1240. That is, as shown in FIG. 18, for example, when the sticking probability for blocks is increased as in the case when the sticking occurs in the lower end of the input image data, the image display apparatus limits the peak gradation for the blocks and controls the emission time to a minimum so that the sticking control for areas and luminance of an area in which the sticking does not occur are maintained as it is.

As shown in FIG. 19, the image display apparatus according to an exemplary embodiment changes and outputs a high gradation value according to a comparison result of data of consecutive unit frames, that is data between the previous frame and the current frame (S1901). The image display apparatus divides the input unit frame into a plurality of blocks, compares the image data between the previous frame and the current frame for the divided blocks, and changes and outputs high gradation values of a specific block according to a comparison result. Here, in the comparison process, the pixel values are compared. The difference between the pixel values is compared with the reference value, corresponding pixels equal to or less than the reference value are accumulated and stored. The high gradation values are changed and output based on characteristics of the accumulated pixels, that is, the temporal change rate. In this process, the brightness of the accumulated pixels may be calculated and provided to adjust the emission time and may be used in changing the pixel value. The contents are fully described in description of the image processor of FIG. 12 and thus detailed description thereof will be omitted.

Subsequently, the image display apparatus drives an area of a color light-emitting element receiving the change high gradation value differently from the surrounding areas (S1903). Here, the driving the area differently from the surrounding areas controls the emission time by the limit of change in the gradation value to improve the sticking phenomenon since the gradation value is changed based on the temporal change rate of the original high gradation value through determination of the occurrence of image sticking. Therefore, the area of the light-emitting element receiving the high gradation value has the driving time different from the surrounding areas.

Further, the image display apparatus generates and outputs control signals for differently or separately control the driving times of the color light-emitting elements for areas based on the changed high gradation value or the brightness information (S1905). In other words, since it can be seen that the high gradation value in the specific block is changed according to the data comparison result, the image display apparatus may receive coordinate values of the corresponding block and generate a PWM signal for controlling the emission time of the block. Thus, when a triangle-wave generator is used, the image display apparatus may generate the duty ratio-controlled PWM signal according to the rise and fall of a DC voltage level.

Subsequently, the image display apparatus outputs the high gradation values for blocks to the display panel 1240 and controls the duty ratio of the control signal to be adjusted based on the high gradation value (S1907). In other word, the image display apparatus provides the generated PWM signal to the corresponding blocks to control the emission time of the color light-emitting element.

Accordingly to the image display method of an exemplary embodiment can partially control the luminance of the area in which the sticking occurs to prevent the sticking phenomenon in advance and thus extend lifespan of the display panel when compared with the related art.

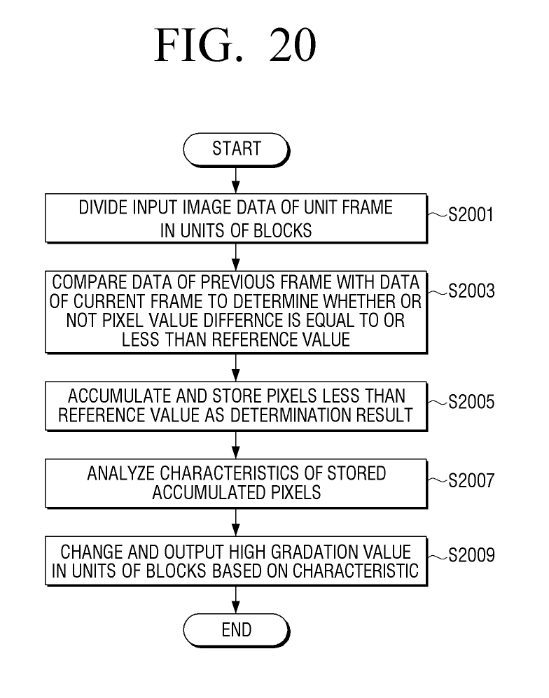

FIG. 20 is a view illustrating an image conversion method according to the second exemplary embodiment.

Referring to FIG. 20 together with FIG. 14, the image processor 1220 of the image display apparatus receives input image data of a unit frame and divides the image data in units of blocks (S2001). The blocks may be divided into various sizes such as 16×16, 8×8, 4×4, 16×8, or 8×4.

The image processor 1220 compares pixel values between previous frame data and current frame data for blocks to determine whether or not the comparison result is equal to or less than a reference value (S2003). As described above, when there is no difference between the pixel values, the probability in which a corresponding pixel is maintained with high gradation for a constant period of time may be preferentially estimated.

Next, the image processor stores pixels equal to or less than the reference value as a determination result (S2005).

Further, the image processor 1220 analyzes a characteristic using the stored pixels (S2007). Here, the characteristics using the pixels adds a weight value by applying a time function as a period of time continues, and calculates the brightness through the analysis of the pixels.

The image processor changes and outputs the high gradation values in units of blocks according to the characteristic analysis result (S2009). In this case, the image processor 1220 may output the corresponding brightness information together with the high gradation value. Since the change of the high gradation value may be limited, the brightness information may be used to control the emission time of the light-emitting elements receiving the high gradation value.

The image display method according to the exemplary embodiments has been described to be embodied in the image display apparatus having the configuration of FIG. 12 above, but may be embodied in the other image display apparatuses having different configurations. Therefore, the image display method is not particularly limited to be embodied in the above-described image display apparatus.

The foregoing exemplary embodiments and advantages are merely exemplary and are not to be construed as limiting the present inventive concept. The exemplary embodiments can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. An apparatus for displaying images, comprising:
an image processor configured to receive an image frame and convert a gradation value of each pixel of a plurality pixels constituting the image frame to generate a sub image frame; and
a controller configured to drive a display panel to sequentially display the image frame and the sub image frame.

2. The apparatus as claimed in claim 1, wherein the image processor generates the sub image frame by converting the gradation value of each pixel of the plurality of pixels of the image frame according to a relation equation V_{sub}=Vₘₐₓ−Vₘₐᵢₙ, wherein V_{sub} is a gradation value of a pixel from among the plurality of pixels of the sub image frame, Vₘₐₓ is a maximum gradation value, and Vₘₐᵢₙ is a gradation value of a pixel from among the plurality of pixels of the image frame.

3. The apparatus as claimed in claim 1, wherein the controller drives the display panel to display the sub image frame during a display time which is shorter than a display time of the image frame.

4. The apparatus as claimed in claim 1, wherein image processor generates the sub image frame by converting the gradation value of each pixel of the plurality of pixels of the image frame based on a luminance difference between a target luminance value corresponding to the gradation value of each pixel of the plurality of pixels of the image frame and a real luminance value.

5. The apparatus as claimed in claim 4, wherein the image processor controls a gamma value to adjust a maximum luminance and a minimum luminance of the sub image frame.

6. The apparatus as claimed in claim 1, wherein the controller determines a display time of the sub image frame based on a luminance difference between a target luminance value corresponding to a gradation value of the image frame and a real luminance value and drives the display panel to display the sub image frame for the determined display time.

7. The apparatus as claimed in claim 6, wherein the controller controls the display time so that a maximum luminance value in the luminance difference is a maximum luminance of the sub image frame and a minimum difference value in the luminance difference is a minimum luminance of the sub image frame.

8. The apparatus as claimed in claim 1, wherein a display time of the sub image frame is changed.

9. An apparatus for displaying images, comprising:
an image processor configured to compare image frames and perform conversion of a gradation value of a block from among a plurality of blocks when consecutive image frames including the block having the gradation value within a preset range are present; and
a display panel configured to display the image frames having gradation values converted in the image processor.

10. The apparatus as claimed in claim 9, further comprising a frame storage configured to store the image frames,
wherein the image processor determines whether or not the consecutive image frames including the block having the gradation value within the preset range are present by comparing the image frames stored in the frame storage, and performs the conversion of the gradation value of the block from among the plurality of blocks within at least one image frame of the consecutive image frames.

11. The apparatus as claimed in claim 9, wherein the image processor performs the conversion of a gradation value on the block from among the plurality of blocks having the gradation value within the preset range in image frames subsequent to the consecutive image frames.

12. The apparatus as claimed in claim 9, further comprising:
a controller configured to determine a driving time corresponding to the gradation value of the block from among the plurality of blocks, and
a light-emitting controller configured to control the display panel to be emitted in the block from among the plurality of blocks according to the determined driving time.

13. The apparatus as claimed in claim 9, wherein the image processor provides a frame accumulation result in which gradation values that are greater than a predetermined gradation values are accumulated for each block of the plurality of blocks, and
the controller controls the light-emitting controller to adjust the driving time of the image frame for each block of the plurality of blocks based on the frame accumulation result.

14. The apparatus as claimed in claim 9, wherein the image processor adjusts a change range of the gradation values which are greater than a predetermined gradation value according to a difference value between the consecutive image frames and a temporal retention degree of the difference value.

15. The apparatus as claimed in claim 9, wherein the image processor increases the change range of the gradation values which are greater than a predetermined gradation value when a temporal retention degree is greater than a predetermined temporal retention degree.

16. The apparatus as claimed in claim 9, wherein the image processor sets a driving time of a color light-emitting element in the display panel to be shortened when a temporal retention degree is greater than a predetermined temporal retention degree.

17. An apparatus for displaying images, comprising:
an image divider configured to divide an image frame into block units;
a frame comparison device configured to compare a difference between a pixel value of previous frame data and a pixel value of current frame data in units of blocks and determine whether or not a comparison result is equal to or smaller than a reference value;
a storage configured to accumulate pixels in which the comparison result is equal to or smaller than the reference value as a result of the determination and store the accumulated pixels;
a property analyzer configured to analyze properties of the accumulated pixels stored in the storage; and
a pixel value adjuster configured to change gradation values greater than a predetermined gradation value of the accumulated pixel in units of blocks based on the analysis result of the property analyzer and output the changed gradation values.

18. The apparatus as claimed in claim 17, wherein the property analyzer comprises a time function weighting device configured to weight a time function according to a frequency of the pixels accumulated in units of blocks, and
the pixel value adjuster uses the weighting result as the analysis result.

19. The apparatus as claimed in claim 18, wherein the time function weighting device adds a higher weight value to the time function as the frequency becomes larger.

20. The apparatus as claimed in claim 17, wherein the property analyzer comprises a brightness calculator configured to calculate average brightness of the accumulated pixels in units of blocks, and
the pixel value adjuster uses the calculation result of the average brightness of the brightness calculation calculator as the analysis result.

21. The apparatus as claimed in claim 20, wherein the pixel value adjuster adjusts a change range of the gradation values greater than the predetermined gradation value based on a difference value between the consecutive image frames and a temporal retention degree of the difference value.

22. The apparatus as claimed in claim 21, wherein the pixel value changing adjuster increases the change range of the gradation values greater than the predetermined gradation value when the temporal retention degree is greater than a predetermined temporal retention degree.

23. A method of displaying images, comprising:
receiving an image frame and generating a sub image frame by converting a gradation value of each of a plurality of pixels constituting the image frame; and
driving a display panel to sequentially display the image frame and the sub image frame.

24. The method as claimed in claim 23, wherein the generating a sub image frame generates the sub image frame by converting the gradation value of each pixel of the plurality of pixels of the image frame according to a relation equation V_{sub}=Vₘₐₓ−Vₘₐᵢₙ, wherein V_{sub} is a gradation value of a pixel from among the plurality of pixels of the sub image frame, Vₘₐₓ is a maximum gradation value, and Vₘₐᵢₙ is a gradation value of a pixel from among the plurality of pixels of the image frame.

25. The method as claimed in claim 23, wherein the driving a display panel drives the display panel to display the sub image frame during a display time which is shorter than a display time of the image frame.

26. The method as claimed in claim 23, wherein the generating a sub image frame generates the sub image frame by converting the gradation value of each pixel of the plurality of pixels of the image frame based on a luminance difference between a target luminance value corresponding to the gradation value of each pixel of the plurality of pixels of the image frame and a real luminance value.

27. The method as claimed in claim 26, wherein the generating a sub image frame controls a gamma value to adjust a maximum luminance and a minimum luminance of the sub image frame.

28. The method as claimed in claim 23, wherein the driving the display panel determines a display time of the sub image frame based on a luminance difference between a target luminance value corresponding to a gradation value of the image frame and a real luminance value and controls the display panel to display the sub image frame for the determined display time.

29. The method as claimed in claim 28, wherein the driving a display panel controls the display time so that a maximum luminance in the luminance difference is a maximum luminance of the sub image frame and a minimum difference in the luminance difference is a minimum luminance of the sub image frame.

30. The method as claimed in claim 23, wherein a display time of the sub image frame is changed.

31. A method of display images, comprising:
comparing image frames and performing conversion of a gradation value of a block from among a plurality of blocks when consecutive image frames comprising the block having the gradation value within a preset range are present; and
displaying the image frames having the converted gradation value.

32. The method as claimed in claim 31, further comprising storing the image frames,
wherein the performing conversion of the gradation value of the block from among a plurality of blocks determines whether or not the consecutive image frames including the block having the gradation value within the preset range is present by comparing the stored image frames, and performing the conversion of the gradation value of the block from among the plurality of blocks within at least one image frame of the consecutive image frames.

33. The method as claimed in claim 31, wherein the performing conversion of the gradation value of the block from among the plurality of blocks performs the conversion of the gradation value on the block having the gradation value within the preset range in image frames subsequent to the consecutive image frames.

34. The method as claimed in claim 31, further comprising;
determining a driving time corresponding to the gradation value of the block from among the plurality of blocks; and
performing a display operation on the block from among the plurality of blocks according to the determined driving time.

35. The method as claimed in claim 31, wherein the performing conversion of the gradation value of the block from among the plurality of blocks provides a frame accumulation result in which gradation values that are greater than a predetermined gradation values are accumulated for each block of the plurality of blocks,
the controller adjusts a driving time of the image frame for each block of the plurality of blocks based on the frame accumulation result.

36. The method as claimed in claim 31, wherein the performing conversion of the gradation value of the block from among the plurality of blocks adjusts a change range of the gradation values which are greater than a predetermined gradation value based on a difference value between the consecutive image frames and a temporal retention degree of the difference value.

37. The method as claimed in claim 36, wherein the performing conversion of the gradation value of the block from among the plurality of blocks increases the change range of the gradation values which are greater than a predetermined gradation value when the temporal retention degree is greater than a predetermined temporal retention degree.

38. The method as claimed in claim 37, wherein the performing conversion of the gradation value in units of blocks sets a driving time of the block from among the plurality of blocks on which the conversion of the gradation value is performed to be shortened when the gradation value greater than the predetermined gradation value.

39. A method of displaying images, comprising:
dividing the image frame into block units;
comparing a pixel value of previous frame data with a pixel value of current frame data in units of blocks and determining whether or not the comparison result is equal to or smaller than a reference value;
accumulating and storing pixels in which the comparison result is equal to or smaller than the reference value as a result of the determination result;
analyzing properties of the accumulated pixels; and
changing and outputting gradation values of the accumulated pixels that are greater than a predetermined gradation value in units of blocks based on the analysis result.

40. The method as claimed in claim 39, wherein the analyzing properties comprises weighting a time function according to a frequency of the accumulated pixels in units of blocks, and
the changing and outputting gradation values uses the weighting result as the analysis result.

41. The method as claimed in claim 40, wherein the weighting sets a higher weight value as the frequency becomes larger.

42. The method as claimed in claim 39, wherein the analyzing properties comprises calculating an average brightness of the accumulated pixels in units of blocks, and
the changing and outputting the gradation values uses a result of the average brightness as the analysis result.

43. The method as claimed in claim 39, wherein the changing and outputting the high gradation values adjusts a change range of the gradation values greater than the predetermined gradation value based on a difference value between the consecutive image frames and a temporal retention degree of the difference value.

44. The method as claimed in claim 39, wherein the changing and outputting the high gradation values increases the change range of the gradation values greater than the predetermined gradation value when the temporal retention degree greater than a predetermined temporal retention degree.
